(19) United States
(12) Patent Application Publication
(10) Pub. No.: US 2012/0004946 A1
(43) Pub. Date: Jan. 5, 2012

(54) Integrated Operational Risk Management

(75) Inventors: Kristen B. Blackwood, Fort Mill, SC (US); Andrew M. Bridgeman, Charlotte, NC (US); Grace Baltusnik, Charlotte, NC (US)

(73) Assignee: BANK OF AMERICA CORPORATION, Charlotte, NC (US)

(21) Appl. No.: 13/171,894

(22) Filed: Jun. 29, 2011

Related U.S. Application Data
(60) Provisional application No. 61/360,768, filed on Jul. 1, 2010.

(51) Int. Cl. G06Q 10/00

(52) U.S. Cl. 705/7.28

(57) ABSTRACT

Systems, methods, and software are described that may be used to integrate assessments of certain types of operational risks, including forecasted emerging (future) risks, current risks, and/or historical realized risks.

### CROSS-REFERENCE TO RELATED APPLICATIONS

The present application claims priority to, and is a non-provisional of, Provisional U.S. Patent Application Ser. No. 61/360,768, entitled, “Integrated Operational Risk Platform,” filed Jul. 1, 2010, hereby incorporated by reference as to its entirety.

### BACKGROUND

Those who have been in the operational risk management industry over the past decade or so understand the challenges associated with the field. As a risk manager, you look under every stone, around every corner to determine what can go wrong and what that wrongdoing could mean for your company. You then need to determine what costs and what levels of management need to be involved in an effort to reduce the risk of an operational event from occurring that may not have ever occurred in the past. Management has different emotional reactions to levels of vulnerability that can support, or refute, the function of the operational risk manager.

The field has long been focused on the art of risk management more so then the science that can lie within it. Questions that, while seeming straightforward at the surface, can be actually quite difficult to answer with an appropriate level of confidence and precision. Example of such questions may be: “How do you expect your capital numbers to vary in the next 5 years?” “What tangible benefit is a company receiving for the large number of risk management professionals' it employs?” “How can you ‘prove’ that you mitigated risk if an event has never occurred in the first place?” “How much spend should be allocated to building controls for a risk that has never realized.” The risk manager typically provides a verbose answer to these questions, but in the end, struggles to make a meaningful, impactful response to the asker.

Moreover, the management of operational risk in a business or other entity has become increasingly important. For example, in the context of the financial services industry, certain compliance regulations such as Basel II and the Sarbanes-Oxley Act mandate an increased focus on managing operational risk. It has therefore become desirable to increase the effectiveness of operational risk management processes.

### SUMMARY

One way to potentially improve operational risk management processes is to integrate assessments of certain types of operational risks, including forecasted emerging (future) risks, current risks, and/or historical realized risks. For example, emerging risks may be forecasted based on assessed current risks and/or historical realized risks, and current risks may be assessed based on the assessed forecasted emerging risks and/or historical realized risks. Such integration may potentially enable holistic aggregation and/or assessment of operational risks across an enterprise, and may enhance usability, transparency, and/or consistency of any existing or future operational risk management process. In some embodiments, this may be accomplished by bringing together otherwise disparate systems and processes to one aligned and integrated end-to-end solution.

In accordance with some aspects as described herein, for example, a method, system, and/or software may be provided for performing some or all of the following: determining a plurality of items of current risk data; determining a plurality of items of realized risk data; determining a plurality of items of emerging risk data; determining, by a computer, a single value representing operational risk based on a combination of the plurality of items of current, realized, and emerging risk data; and causing a representation of the determined single value to be displayed by a display device.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a functional diagram metaphorically showing an example of interdependencies between current, realized, and emerging risks, in accordance with one or more aspects as described herein;

FIG. 2 is an example block diagram showing how the respective operational risk measures may be displayed and reconciled, in accordance with one or more aspects as described herein;

FIG. 3 is a functional diagram of an example integrated operational risk management platform, in accordance with one or more aspects as described herein;

FIG. 4 is an example graph, in accordance with one or more aspects as described herein;

FIG. 5 is another example graph, in accordance with one or more aspects as described herein;

FIG. 6 is a block diagram of an example computer, in accordance with one or more aspects as described herein;

FIG. 7 is an example screen shot of a report that may be displayed as a user interface by the integrated operational risk management platform, in accordance with one or more aspects as described herein;

FIG. 8 is another example screen shot of a report that may be displayed as a user interface by the integrated operational risk management platform, in accordance with one or more aspects as described herein;

FIG. 9 is yet another example screen shot of a report that may be displayed as a user interface by the integrated operational risk management platform, in accordance with one or more aspects as described herein; and

FIG. 10 is a flow chart showing example steps, some or all of which may be performed by a computer, in accordance with one or more aspects as described herein.

### DETAILED DESCRIPTION

Techniques discussed herein may potentially allow one to provide better answers to risk assessment inquiries. For instance, in accordance with concepts described herein, the following example answers may be able to be provided to various questions, such as:
Q: How do you expect your capital numbers to vary in the next five years? A: Our model forecasts with 90% confidence that capital numbers in five years to range between x and y dollars.
Q″ What tangible benefit is a company receiving for the large number of risk management professionals it employs? A: Our risk profile has improved 2000 points over the last year (an average of 5 points per person) resulting in a decrease in operational losses $×; 3 times more than the overhead of the employee pool.
Q: How can you show that you mitigated risk if an event has never occurred in the first place? A: Through statistical modeling of similar risks and events, we can demonstrate a statistically significant decrease in risk related damages of X % due to the improvements in the control environment
Q: How much spend should be allocated to building controls for a risk that has never realized? A: Based on the risk modeling, X dollars should be the maximum spend for Y risk given losses of similar type and the current risk appetite of the business.

Of course, the above questions, answers, and values are merely examples. There are many other questions that may be answered in a more concrete way using concepts described herein. As will be described herein, a way to answer these questions with some confidence may involve providing an architecture that may be able to balance qualitative assessments with quantitative assessments across current risks, forecasted risks, and realized risks.

This may be put into perspective using a real estate example. Assume, for instance, that you want to purchase an investment property that is expected to increase in value by 20% over a five-year time frame. In order to meet your objective with a given level of confidence, you might conduct research to enable you to predict the value of a property in the timeframe you request. This may determine how attractive the investment is and may ultimately be the basis for which your decisions are made. After finding a potential property, you might obtain an appraisal based on the size of the house, the plot of land, the amenities, etc. You might then pull a list of comparables to see what similar houses have sold for over the past two years. You investigate the community. You might find answers to questions such as, what is the crime rate of the area? What is the school district like? What conveniences are in the surrounding two miles? Have vacant properties been purchased that are zoned for a major build? What has the growth rate been for the surrounding area, and what is it forecasted to be? What are the forecasts for household income over the next five years?

These types of questions yield answers that are generally driven by fact. Rather than relying on a real estate agent telling you “this is a great find,” you have collected data to support your decision making process. By gathering historical, current, and forecasted data, one can try to make a sound decision, with an elevated level of confidence, that the objective can be met.

The above real estate example may be similar in many ways to advanced thinking that may be involved in conducting operational risk management. In the real estate example, we may have collected, for example, the following data sets shown in Table 1.

TABLE 1

| Historical | Current | Forecast |
|---|---|---|
| Previous sales over | Appraisal based on: | Real estate forecasts |
| past two years | property type, | Recent zoned purchases |
| Crime rate | lot size, | Growth forecasts |
| Growth rate | bedrooms/baths, | Crime Forecasts |
| Household income | square footage | Household Income Forecasts |
| Unemployment rate | Assessment of | Unemployment Rate |
| | surrounding area | |
| | Amenities | |
| | School District | |
| | Location/Proximity | |

As can be seen in Table 1, the various data sets are divided into historical data, current data, and forecast data. While operational risk management is a relatively new discipline, it may be desirable to start thinking about operational risks in these same parameters—realized (historical) risks, current risks, and emerging (forecast) risks. An example of this is shown in Table 2. Given the economic environment and regulatory reform such as pending Basel III, one can no longer necessarily take comfort in qualitative assessments alone. Thus, it may be desirable to bring together operational risks processes and data into one integrated architecture resulting in an end-to-end solution that will allow for adequate prediction, mitigation, control, and/or prevention of operational risks.

TABLE 2

| Realized Risks | Current Risks | Emerging or Forecast Risks |
|---|---|---|
| Internal Operational | Risk and Control | Scenario Analysis |
| Losses | Assessments (BAU) | Early warning indicators |
| External Operational | Change related | |
| Losses | risk assessments | |
| Key indicators that | (ex. Transition, | |
| have breached | new product, etc) | |
| thresholds | | |
| Control Failures | | |

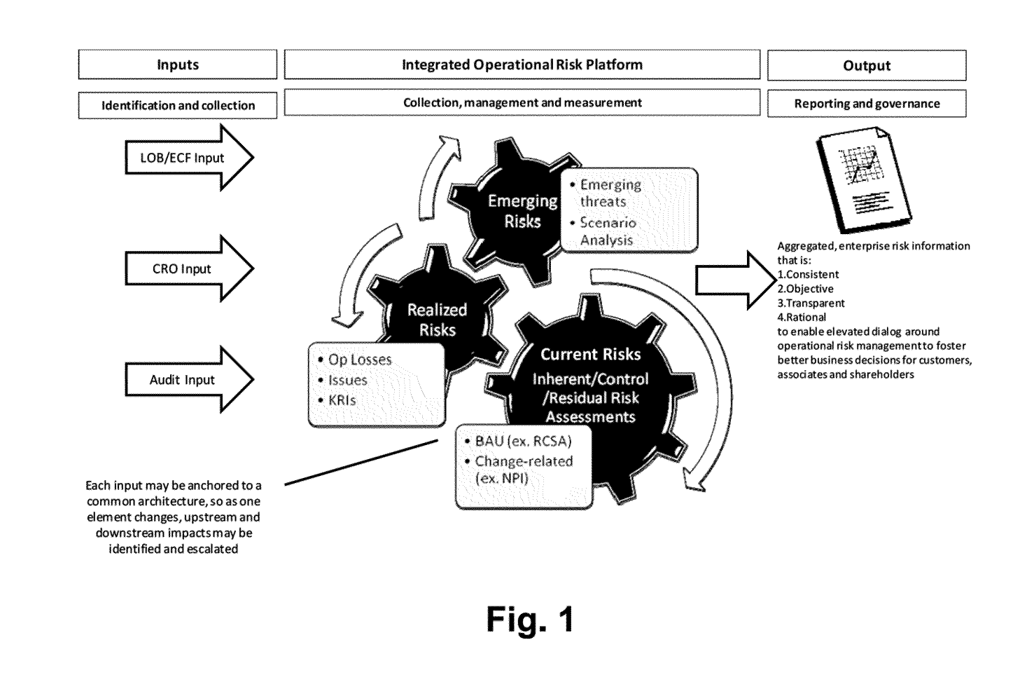

These three risk categories (realized, current, and emerging) may be thought of as three interdependent gears, such as shown in FIG. 1. As shown in FIG. 1, assessments of emerging risks may include, for example, assessments of emerging threats and/or scenario analysis. Assessments of realized risks may include, for example, operational losses, issues, and key risk indicators (KRIs). Assessments of current risks may include, for example, business-as-usual (BAU), such as risk and control self-assessment (RCSA), and/or change-related analysis, such as new product introduction (NPI).

Inputs to the integrated operational risk platform may include, for example, information collected from business functions such as line-of-business (LOB), enterprise control function (ECF), and/or chief risk operators/officers (CRO), and/or from audit results. Each input to the system may be anchored to a common architecture, such that as each element changes, upstream and downstream impacts may be identified and/or escalated by the system and/or by users of the system.

The integrated operational risk platform may provide one or more outputs in human-readable and/or computer-readable form. The output information may include, for example, enterprise risk information that is consistent, objective, transparent, and/or rational, and may be of a nature sufficient to enable elevated dialog around operational risk management. This, in turn, may foster better business decisions for the business's customers, associates, and/or shareholders.

As one “gear” changes in the conceptual illustration of FIG. 1, one or both of the other two may change as well. In other words, if one or more of realized risk, current risk, and/or emerging risks changes, this may impact one or more of the other of the realized, current, and/or emerging risks. The impact to the remaining gears (risk categories) may be of relative scale. For example, assume that a large external loss has occurred at a key competitor. In accordance with concepts as described herein, a notification may be sent to the owner of the corresponding risk(s) to assess their own risks and controls for further vulnerabilities. The result of the assessment may be sent to an emerging risk team for monitoring.

As another example, assume that a large internal operational loss occurs. In this case, a notification may be sent to the appropriate risk assessment owner that the actual (realized) losses no longer correlate to existing risk assessment scores. This may trigger some action on the part of the risk owner (e.g., a rating change or a justification), and may impact the loss forecasts communicated to executive management to revisit risk appetite.

As another example, assume that a risk rating has changed on a risk assessment from low to high. In response to determining this, the thresholds for the monitoring indicators may be decreased (e.g., made more sensitive). Additionally, this newly found high risk may feed to a potential scenario for which future analysis may be performed.

As yet another example, assume that a product is being introduced that is new to the business model. As such, there may exist new regulations that are now in scope. Revenue gains may be expected, as may some operational losses. Such a current assessment may impact the loss forecast and may also cause key indicators to be established to monitor for compliance.

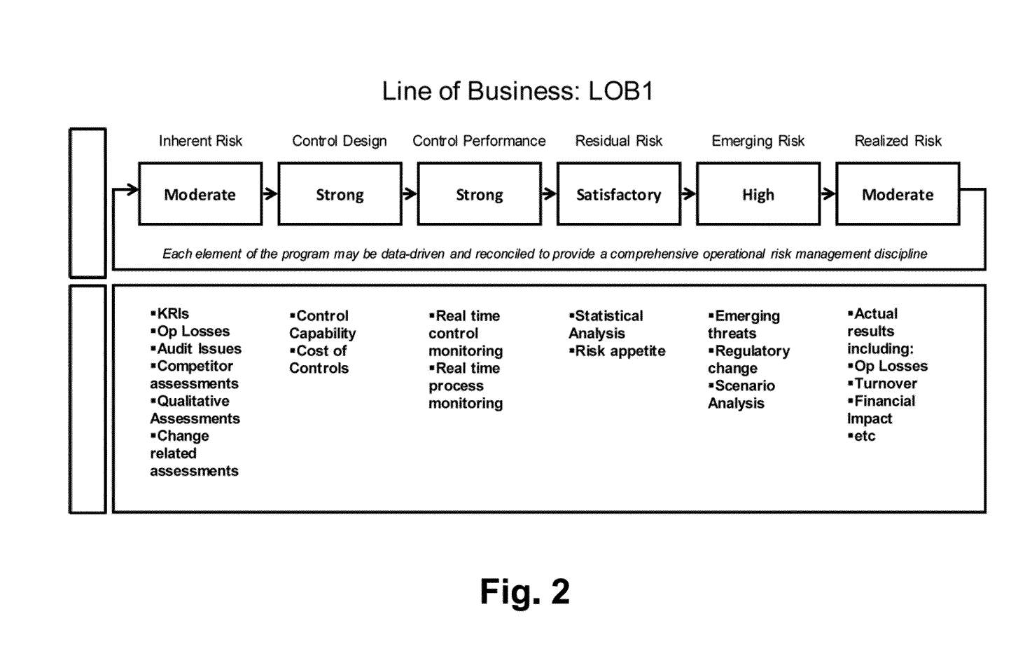

Referring to FIG. 2, a functional block diagram is shown of an example interdependency of various operational risk assessment functions in the integrated operational risks platform. The functional blocks assess various types of operational risks and controls, such as inherent risk, control design, control performance, residual risk, emerging risk, and realized risk. The particular interdependencies shown are merely an example; other interdependencies may be implemented as desired. FIG. 2 also shows example inputs to the platform at the various functional blocks, as well as an example high-level assessment (e.g., moderate risk, strong, satisfactory, high risk) as determined at each functional block for a particular line of business (LOB), referred to by way of example as LOB1. Different assessments may be made for each line of business or other portion of a business entity, as desired.

To obtain an integrated operational risk management system of qualitative and quantitative assessments across the current, emerging and realized risk dimensions, some or all of the following elements may be utilized: (1) an operational risk architecture, (2) an aggregation and analysis of operational risk data, and/or (3) a risk model. Each of these elements, which will be discussed in turn below, may be implemented as one or more hardware and/or software components.

### Operational Risk Architecture

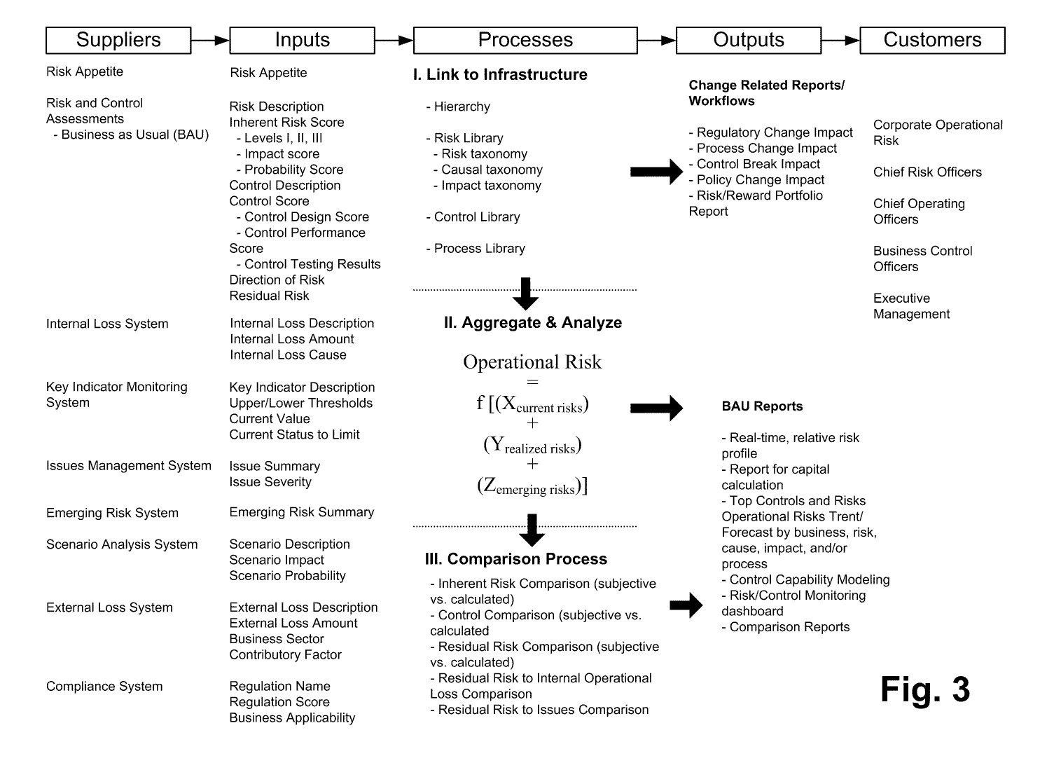

An operational risk architecture, functionally shown by way of example in FIG. 3, may be provided that may be used to enable assessment of realized, current, and/or emerging risk landscapes, as well as provide a foundation for managing these risks by facts and data. Operational risk data elements may be decomposed and organized, and their interrelationships defined. The relationships between the operational risk data elements may define connections from the elements to common architectures and/or to others of the element, which may involve providing, for example, the following four libraries that may be anchored by a standard taxonomy structure:

Hierarchies Library—A hierarchy may be created that indicates a tree structure of the organization of the operational risk data elements. This may be done via, e.g., organizational hierarchy, financial hierarchy, etc., so as to define the organization as a whole at multiple levels. This organizational hierarchy may potentially allow for aggregation of a model of the risks.

Processes Library—An often overlooked step in operational risk management is to identify core processes. This may be accomplished by answering, for example, the following questions. What is your business? What are you trying to accomplish? What defines success? If one understands the processes related to these types of questions, one may be able to decompose the processes into their respective parts and determine “what can go wrong,” also known as identifying the risks.

Risks Library—To allow for quality risk identification, standard risk statements may be broken into multiple distinct risk taxonomies. Together, these taxonomies may allow one to reduce or even minimize the variability in how risks are identified by decomposing them into the three respective elements. In many cases, elements identified as risks have turned out to actually be causes. Or, the risks are in reality merely symptoms of other true operational risks not yet uncovered. As an example, the following three distinct risk taxonomies may be identified:
Inherent Risk—What is the risk being identified? Examples include: Internal identity theft, unauthorized trading, market rules and trading violations, etc.
Cause—What is the cause of that risk? Technology solution delivery, hardware performance, staffing levels, process design, etc.
Impact—What is the impact if the risk becomes realized? Examples include: financial losses, reputational damages, customer dissatisfaction, lost revenue opportunity, etc.

Controls Library—Questions involving control may include, for example, the following. What are the preventive and detective mechanisms in place to ensure the risk does not become realized? How are these controls designed? How are they performing?Examples include: quality assurance reviews, application controls, reconciliation processes, etc.

Once the taxonomies are established, the next step may be to inventory the current operational risks across the company. This is typically done via Risk and Control Assessments. While a large effort, this is the most critical step in the process since it builds the infrastructure for which the subjective assessments are made, and the infrastructure for which the objective elements are normalized, compared and related. It is critical here, that the assessments are holistic in nature and represent the business being assessed, its objectives and its core processes. Many assessments fall short here if they are focused solely on current key risks or realized events rather than assessing the landscape comprehensively and answering such fundamental questions as those posed above. It is also extremely important here to align the assessments to a standard hierarchy.

Each of the taxonomies may include a plurality of different levels in a hierarchical tree structure that may enable the risk data to be aggregated at the top and/or decomposed to the lowest levels. This may potentially allow for transparent and rational reporting and evaluation.

In addition to aligning Risk and Control Assessments to the architecture outlined above, the remainder of the operational risks management data elements may be aligned as well. Each of the taxonomies outlined may transcend all operational risk data through realized, current and emerging risks. Therefore, it may be desirable that all audit issues, internal losses, external losses, key indicators, emerging risks and scenarios be aligned to the architecture.

### Aggregation and Analysis of Operational Risk Data

Using the architecture and the data aligned to it such as described above and summarized in FIG. 3, the power of integration may be exposed. You may now have a full library packed with your qualitative and/or quantitative risks, with virtually unlimited analysis that can be performed as desired. In some embodiments, each data element may be combined in a meaningful way to result in a model that produces a single value (e.g., a number) summarizing an operational risk. This may be done efficiently especially where the data is aligned to a common architecture as discussed above. The single value for operational risk thus may be determined as a function of current risk, realized risk, and emerging risk:

Operational Risk=f[(AX_{current risks})+(BY_{realized risks})+(CZ_{emerging risks})],

where A, B, and C are coefficients, and X_{current risks}, Y_{realized risks}, and Z_{emerging risks} are functions of their respective types of risk. This relationship may involve, for example, a weighted combination (e.g., summation and/or multiplication) of all realized, current, and emerging risk data. Of course, the particular calculation of the function ƒ would depend upon the particular risks and specifics of the business being managed. As an example, X_{current risks} might be equal to, e.g., (current risk data 1)(current risk data 2)+(current risk data 3)(current risk data 4)−(current risk data 5) . . . . Likewise, Y_{realized risks} and Z_{emerging} risks may have a similar mathematical structure. As will be discussed below, the coefficients A, B, and C may be determined using any type of appropriate analysis, such as statistical (e.g., regression) analysis.

Imagine all of your operational risk data organized and normalized in such a manner, and linked to the taxonomies discussed above that may serve as attributes to analyze and interpret your results. This may give each risk (or aggregation of risk) one number. A score to essentially stack rank and summarize the operational risk landscape.

### Risk Model

By thinking of operational risk data across these three dimensions, aligning it to the architecture, aggregating and analyzing it, you can now understand the relationship among the various risk elements. This may normalize your data, potentially giving more weight to the areas with the greatest risk, and may also allow you to determine the confidence you have in your predictive model. All ‘high’ risks are not considered equal. Thus, such weighting may allow you to stack rank your risks across an entire organization.

### Current State Modeling

Inherent Risk Comparison—Subjective versus calculated. This may be implemented by correlating the overall judgment of level of inherent risk to the calculated scores, which may be obtained such as via a questionnaire framework. For example, inherent risks may be measured via an impact (range 1-5) and probability (range 1-5) score, which when multiplied together would result in a score range of 1-25. This would be the subjective assessment. The calculated assessment may be done via questionnaire. For example, by answering questions, an inherent risks core may be calculated. Examples of such questions may be: What are the number of customers impacted by your business? How many third party service providers are you reliant on? How many regulations impact your business? How many international locations do you operate in? What is the turnover rate of key management positions? Scored answers to these questions may result in scores that can be normalized on a scale (e.g., 1-25 or any other scale) and then may be correlated to the subjective assessments.

Control Comparisons—Subjective versus calculated. A similar philosophy may be implemented here. The subject assessment for controls may be a satisfactory/needs improvement/unsatisfactory scale. The assessment may be further broken into control design and control performance assessments. The calculated control score may be a function of actual risk coverage that the control is responsible for, as well as the actual performance (number of defects, failures, yield rate, etc.). These too, again, may be normalized and compared. If it is determined that the subjective assessments align to the calculated assessments, then more confidence may be placed in that assessment. If not, then it may be decided that confidence levels should be decreased accordingly so as to not bias results.

Residual Risk Comparison—Subjective versus calculated. Residual risks are often categorized as high/moderate/or low. This would be an example of subjective assessment. Subjective assessment may be balanced with a calculated assessment that implements the following relationship: Residual risk=inherent risks−controls.

Comparisons of current risks to realized risks may include, for example, the following comparisons:
1) internal losses,
2) key indicators,
3) outstanding issues, and
4) external losses.

The first three comparisons listed above (corresponding to the “Comparison Process” portion of FIG. 3) may be used to determine the balance between the art of operational risk management and the science resulting in an estimate of precision in the assessments being executed. While one may not expect to see a direct one-to-one comparison of these variables, one may expect to see some correlation between these in a mature operational risk management program. The higher the correlation, the greater confidence levels one can have in the predictive modeling.

### Predictive Modeling

At this point, a robust architecture and framework have been built for which all operational risks may be aligned. This architecture may have been populated with current, emerging, and/or realized quantitative and/or qualitative data. Comparison analyses of each of the discrete key variables may have been performed to determine the precision and accuracy of the operational risk data. Now may be the time to pull the architecture and data into a model that may provide a deeper analysis of the current state, and that may provide predictive capabilities based on the result.

### Statistical Analysis

Statistical analysis is commonly used to predict events such as unemployment rates, gas prices, success of medical trials, etc. It is a proven way to assess a full data set, to understand what variables influence others, and how each of those variables work together to predict an outcome. Everything discussed so far has built the foundation to accomplish this. For example, the following regression analysis may be performed:

f(x)=Intercept+AX_{current risks}+BY_{emerging risks}+CZ_{realized risks}

A similar regression analysis may provide an assessment of current state operational risks. For example, where it is determined that A=0.25, B=0.1, and C=3.2:

f(x)=53.2+0.25X_{current risks}+0.1Y_{emerging risks}+3.2Z_{realized risks}

The output of a regression analysis may indicate the relative weighting, hence the normalization of each of the data elements with respect to each other. This analysis may be implemented using, e.g., a statistical software package. The result of the comparison analysis as a foundation to determine the confidence intervals.

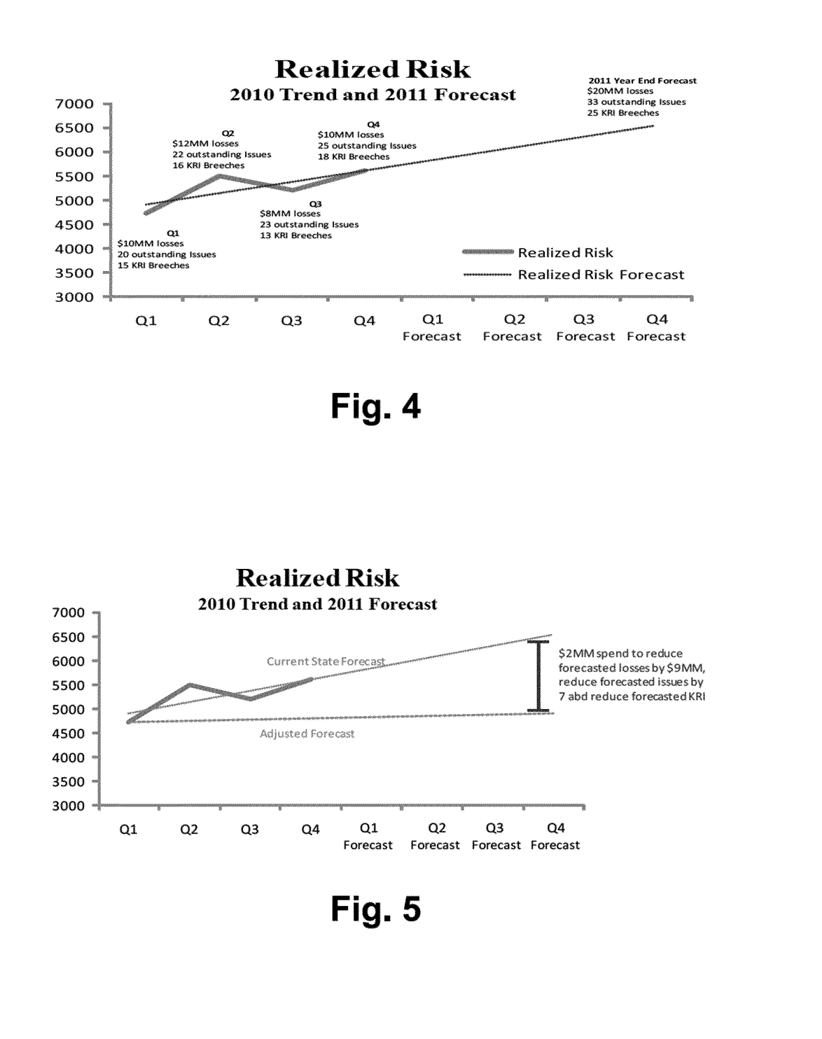

Once the model is built, various predictive analyses can be performed. For example, data forecasts that review time series data and forecast results based on current state model may be implemented. Once the regression equation is derived, one may forecast any risks (such as realized risks) based on the current state model. Such an analysis may assume that no change in the other two risks categories (in this example, current and emerging risks) from the time the model is run, to the time that it is forecasted. FIG. 4 shows an example result of such forecasting analysis.

Since an architecture has been built, as discussed above, for which realized risk can be quantified, aggregated and normalized, a time series analysis may be performed to understand the potential forecast for these realized risks in the future. This may provide a tremendously powerful view that may enable one to answer many of the questions first posed in the Background section of this document. Using the confidence intervals established in the comparison analyses performed, one may be able to determine, for example, with 90% confidence, that given the current risk and control environment, that realized events will increase 17% between year end 2010 and year end 2011. This 17% may include an increase of $10 million in losses, eight new issues, and seven additional key risk indicator (KRI) breaches from prior year. Such a result may be used to drive the business case for the next set of analyses, such as follows.

Scenario Modeling. The next logical question to the original statement of “with 90% confidence that given the current risk and control environment that realized events will increase 17% between year-end 2010 and year-end 2011,” may be: “What needs to be done to bring these numbers down?”

Because the regression equation has been established, this may provide parameters from which one can estimate potential outputs, based on tweaking the inputs. Consider here that the outputs in this example would be the realized risks, and the inputs in this example would be the current risks and the emerging risks. Recalling the metaphorical image of the gears in FIG. 1, if we want to optimize the output (in this example, realized risks), then how can we rotate the other two gears (in this example, current and emerging risks) to give us an acceptable output? To understand this, the following example is proposed. Assume that the regression equation is as follows:

0.6Z_{realized risks}=53.2+0.8X_{current risks}+0.4Y_{emerging risks}

This example result suggests that changes in the current risks have twice the impact to realized risks as it has to emerging risks, since the coefficient value 0.8 is twice the coefficient value 0.4. From there, the current risk equation may be decomposed, for example, to determine which key inputs would yield the greatest return. For example, it may be determined that residual risk rating within the Risk and Control Assessment is a key driver to the current risk score. If the objective is to have a negative trend/forecast for the coming year, than controls could be implemented to move the residual risk value from, say, 500 to 350. Of course, these and all other values discussed herein are merely examples. By targeting the largest residual risks, a control strategy may be developed to meet these requirements. For example, after further analysis, it may be determined that the cost to improve the controls 150 points is $2 million. See, e.g., FIG. 5. One might then use the model to determine the return on that investment. The difference between the current state forecast and the new adjusted forecast including the $2 million control build, may result in, e.g., $9 million less in forecasted losses. This alone may demonstrate the savings that the $2 million investment resulted in, in addition to any other benefits to realized risk that may result in reduced issues and KRI breeches.

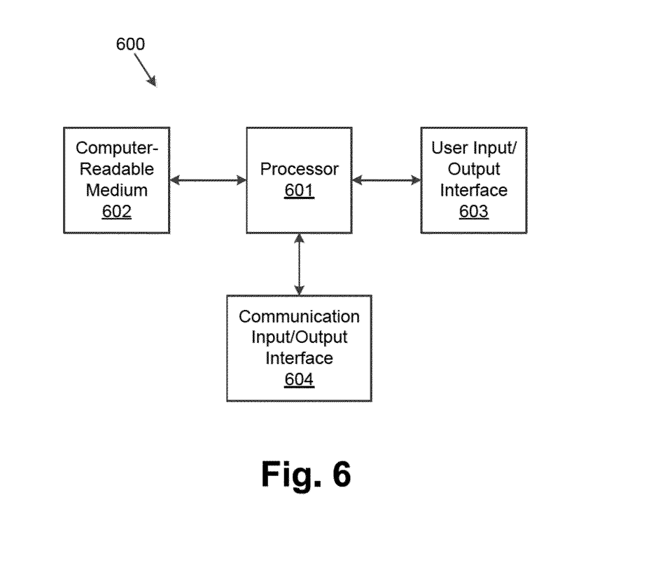

FIG. 6 is a functional block diagram of an example system that may be used to physically embody an integrated operational risk architecture. In this example, the system may be or otherwise include a computer 600, and may include hardware that may execute software to perform specific functions. The software, if any, may be stored on a tangible and/or non-transitory computer-readable medium 602 in the form of computer-readable instructions. Computer 600 may read those computer-readable instructions, and in response perform various steps as defined by those computer-readable instructions. Thus, any functions, steps, calculations, devices, and other elements described herein may be may be implemented by a computer, such as by reading and executing computer-readable instructions for performing those functions, and/or by any hardware subsystem (e.g., a processor 601) from which computer 600 is composed. Additionally or alternatively, any of the above-mentioned functions may be implemented by the hardware of computer 600, with or without the execution of software. For example, computer 600 may be or include one or more microprocessors, central processing units (CPUs), and/or other types of circuitry configured to perform some or all of the functions attributed to computer 600. In such embodiments, processor 601 may be implemented as or otherwise include the one or more microprocessors, CPUs, ASICs, and/or other types of circuitry.

A computer may include any electronic, electro-optical, and/or mechanical device, or system of multiple physically separate or integrated such devices, that is able to process and manipulate information, such as in the form of data. Non-limiting examples of a computer include one or more personal computers (e.g., desktop, tablet, handheld, or laptop), mainframes, servers, and/or a system of these in any combination or subcombination. In addition, a given computer may be physically located completely in one location or may be distributed amongst a plurality of locations (i.e., may implement distributive computing). A computer may be or include a general-purpose computer and/or a dedicated computer configured to perform only certain limited functions.

Computer-readable medium 602 may include not only a single physical non-transitory medium or single type of such medium, but also a combination of one or more such media and/or types of such media. Examples of embodiments of computer-readable medium 602 include, but are not limited to, one or more memories, hard drives, optical discs (such as CDs or DVDs), magnetic discs, and magnetic tape drives. Computer-readable medium 602 may be physically part of, or otherwise accessible by, computer 600, and may store computer-readable instructions (e.g., software) and/or computer-readable data (i.e., information that may or may not be executable).

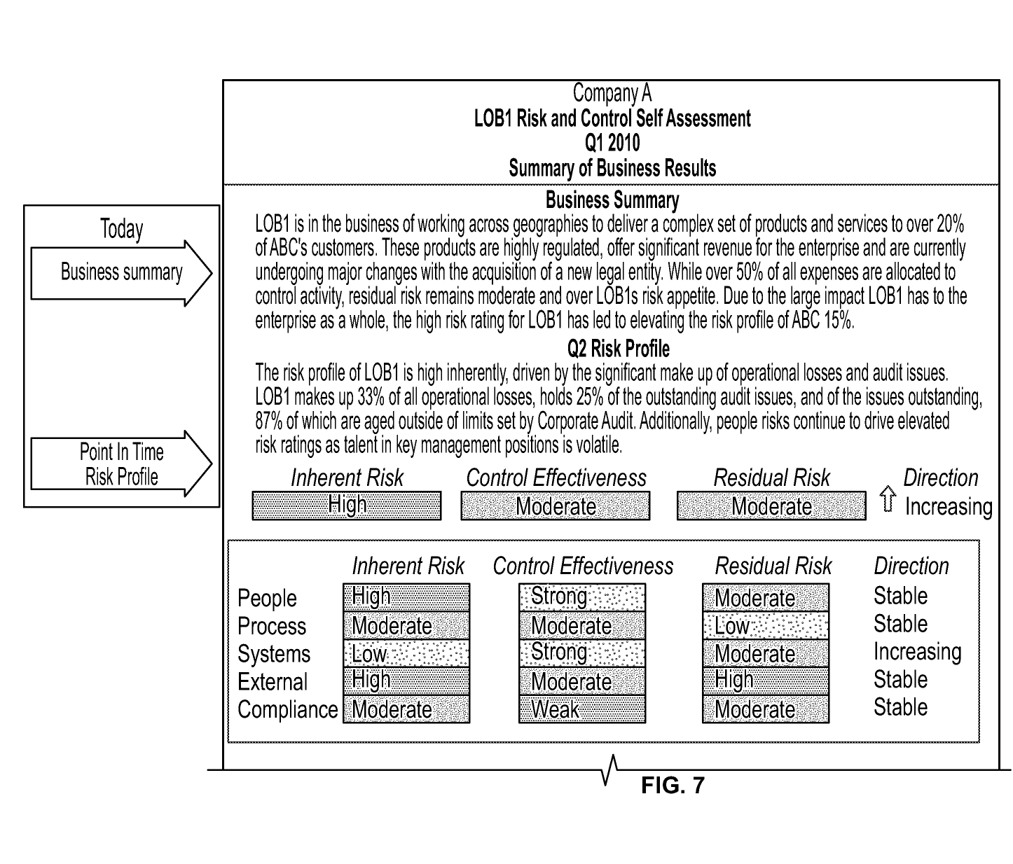

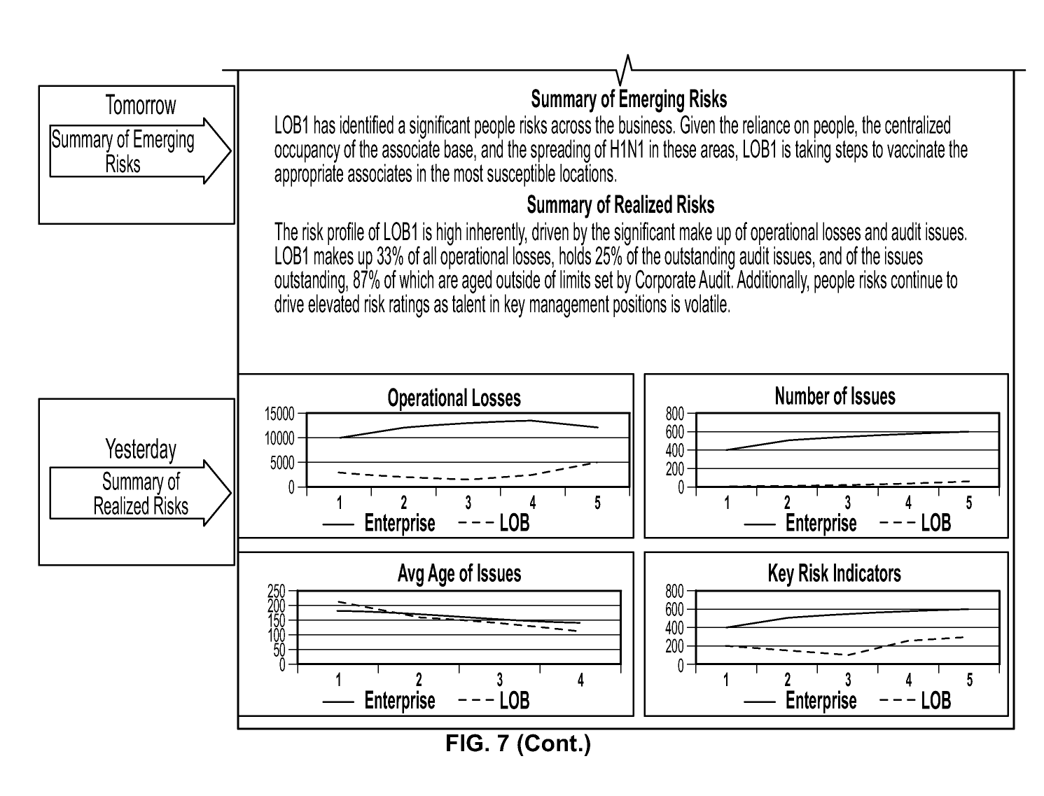

Computer 600 may also include a user input/output interface 603 for receiving input from a user (e.g., via a keyboard, mouse, touch screen, and/or remote control) and providing output to the user (e.g., via a display device, an audio speaker, and/or a printer). Thus, various output information, such as shown in FIGS. 7, 8, and 9, may be provided to such a display device and/or printer, and/or the information may be stored as data in computer-readable medium 602. Computer 600 may further include a communication input/output interface 604 for communicating with devices external to computer 600, such as with other systems and networks.

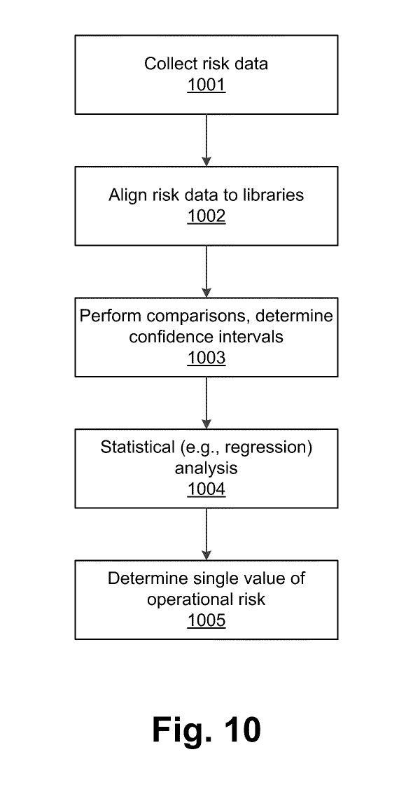

FIG. 10 is a flow chart showing example steps, some or all of which may be performed by a computer such as computer 600. For example, each step in FIG. 10, and each function as described elsewhere in this document, may be implemented by computer 600 executing computer-executable instructions stored on non-transitory computer-readable medium 602. At step 1001, risk data may be collected as discussed above. Next, at step 1002 the collected risk data may be aligned to the appropriate libraries. As discussed above, the libraries may include, for example, a hierarchies library, a processes library, a risks library, and/or a controls library. Then, at step 1003, one or more comparisons may be performed in order to determine one or more confidence intervals. At step 1004, statistical (e.g., regression) analysis may be run to determine operational risk equations. Next, at step 1005, the three dimensions of operational risk—current risk, realized risk, and emerging risk—may be combined to determine a single value of operational risk. For example, as discussed above, the single value of operational risk may be determined according to the following relationship: Operational Risk=f[(AX_{current risks})+(BY_{realized risks)+(CZ}_{emerging risks})].

Examples of reports and other information that may be output (see Outputs, FIG. 3) as a displayed user interface (e.g., on a display device) by the integrated operational risks platform are shown in FIGS. 7, 8, and 9. In this example, output information for line of business LOB1 of an imaginary business entity, called ABC Company, are shown. The output information may include textual and/or graphical information. The output information may further be provided in the context of a predetermined timeframe, which in the present example is quarter 1 of the year 2010. The output information may include, for instance, a business summary, a point-in time (current) risk profile, a summary of emerging risks, and/or a summary of various risks.

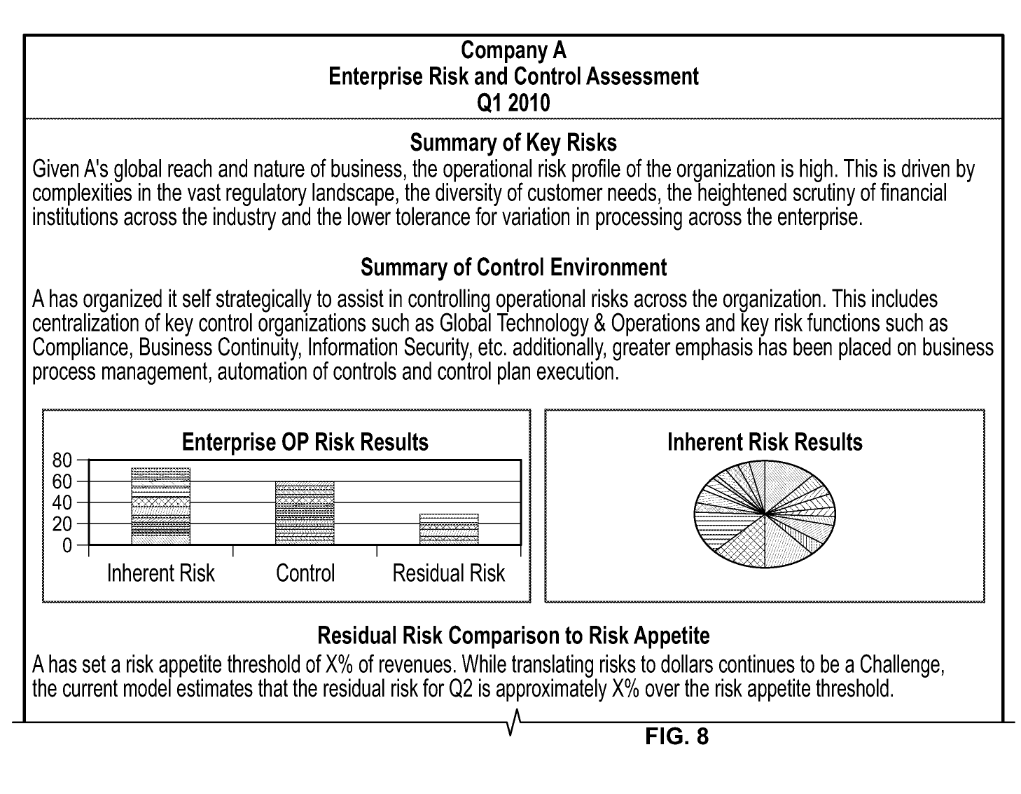

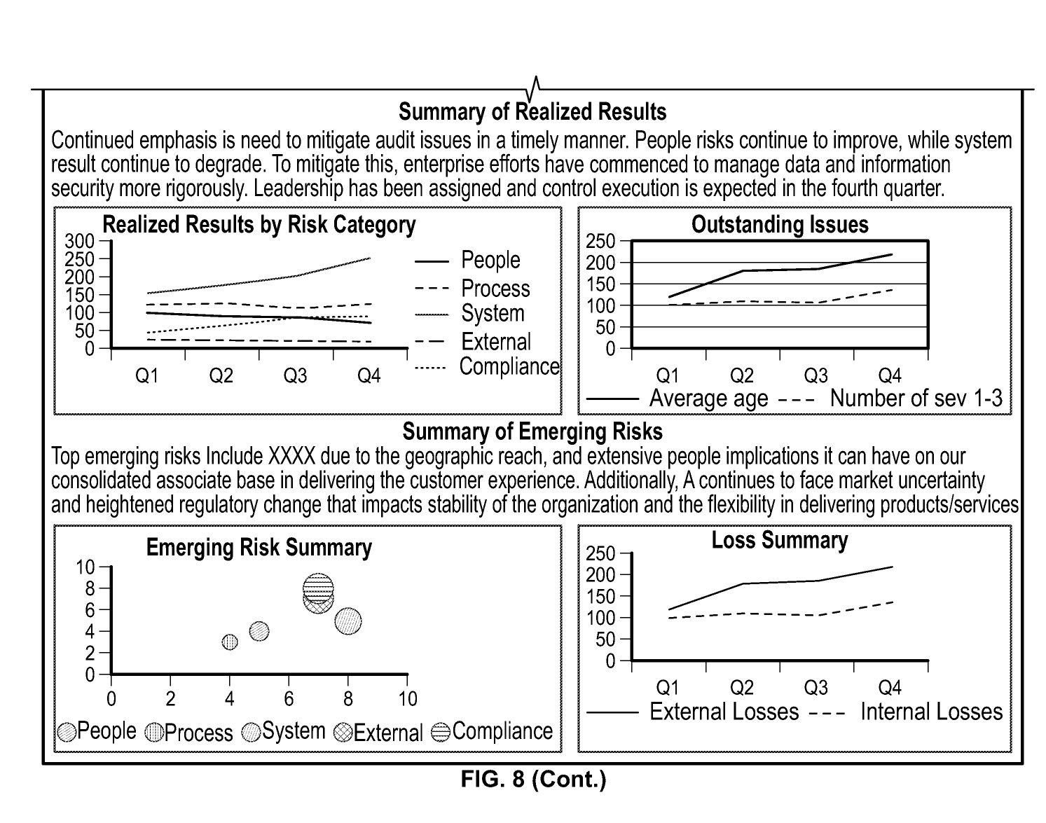

Another example of information that may be additionally or alternatively output is shown in FIG. 8, which may include a summary of key risks, a summary of the control environment, a residual risk comparison to risk appetite, a summary of realized risks, and a summary of emerging risks.

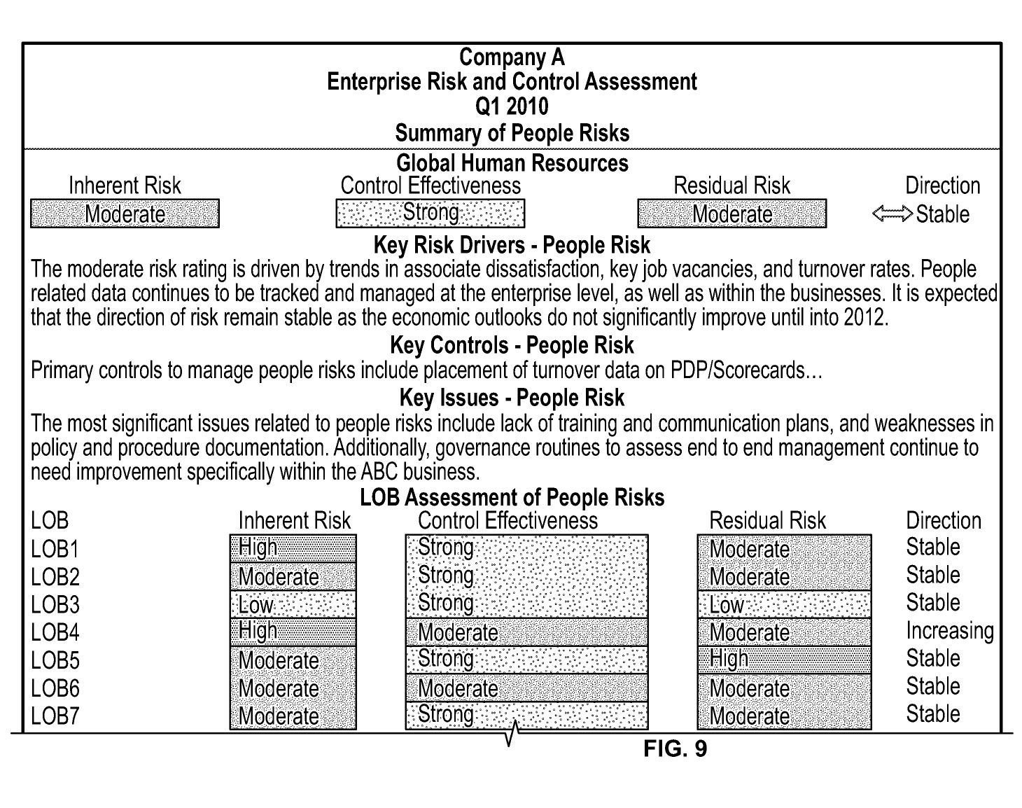

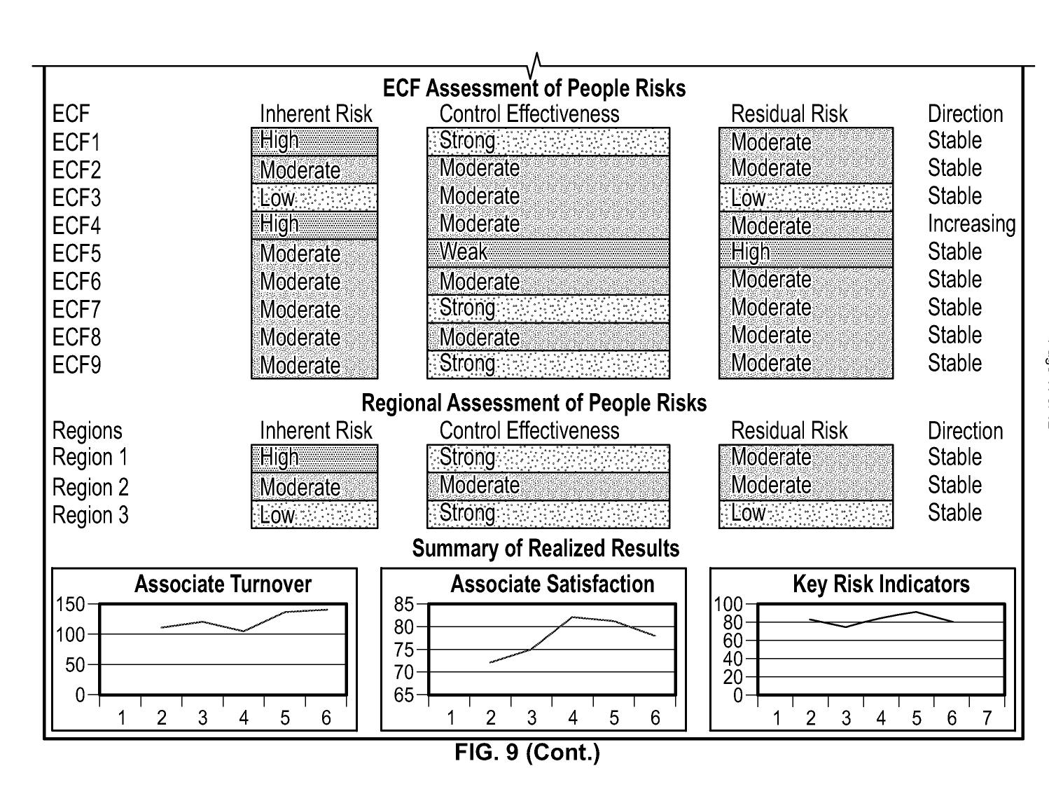

As shown in FIGS. 7 and 8, operational risks may be broken down into various categories such as people risks, process risks, system risks, external risks, and/or compliance risks. Detailed information directed to any of these categories of risks may be further drilled down and provided as an output. An example of such a drill-down output is shown in FIG. 9 in the context of people risks.

While illustrative systems and methods as described herein embodying various aspects of the present disclosure are shown, it will be understood by those skilled in the art that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. Moreover, one of ordinary skill in the art will appreciate that the flowchart steps illustrated in the illustrative figures may be performed in other than the recited order, and that one or more blocks or steps illustrated in any of the figures may be optional in accordance with aspects of the disclosure. The description is thus to be regarded as illustrative of, rather than restrictive on, the present disclosure.

1. A computer, comprising:
a processor; and
a non-transitory computer-readable medium storing computer-executable instructions for performing steps, the steps comprising:
determining a plurality of items of current risk data,
determining a plurality of items of realized risk data,
determining a plurality of items of emerging risk data, and
determining, by a computer, a single value representing operational risk based on a combination of the plurality of items of current, realized, and emerging risk data.

2. The computer of claim 1, wherein the computer-executable instructions are further for causing a representation of the determined single value to be displayed by a display device.

3. The computer of claim 1, wherein determining the single value comprises summing at least some of the items of current risk data with at least some of the items of realized risk data and at least some of the items of emerging risk data.

4. The computer of claim 1, wherein determining the single value representing operational risk further comprises:
determining a first combination of the plurality of items of current risk data;
determining a second combination of the plurality of items of realized risk data;
determining a third combination of the plurality of items of emerging risk data;
and summing together the following: (1) the first combination multiplied by a first coefficient, (2) the second combination multiplied by a second coefficient, and (3) the third combination multiplied by a third coefficient.

5. The computer of claim 4, wherein the computer-executable instructions are further for performing regression analysis to determine the first, second, and third coefficients.

6. The computer of claim 1, wherein the computer-executable instructions are further for collecting risk data, wherein determining the plurality of items of current, realized, and emerging risk data comprises aligning the collected risk data to a plurality of libraries.

7. The computer of claim 6, wherein the computer-executable instructions are further for performing comparisons between the determined plurality of items of current and realized risk data to determine a confidence interval.

8. A method, comprising:
determining a plurality of items of current risk data;
determining a plurality of items of realized risk data;
determining a plurality of items of emerging risk data;
determining, by a computer, a single value representing operational risk based on a combination of the plurality of items of current, realized, and emerging risk data; and
causing a representation of the determined single value to be displayed by a display device.

9. The method of claim 8, wherein determining the single value comprises summing at least some of the items of current risk data with at least some of the items of realized risk data and at least some of the items of emerging risk data.

10. The method of claim 8, further comprising determining a hierarchy of risks, wherein the determined plurality of items of current, realized, and emerging risk data is based on the determined hierarchy of risks.

11. The method of claim 8, further comprising normalizing the plurality of items of current, realized, and emerging risk items of data prior to combining the items of data to determine the single value.

12. The method of claim 8, wherein the items of current risk data comprise inherent, control, and residual risk assessments.

13. The method of claim 8, wherein the items of current risk data comprise key risk indicators.

14. The method of claim 8, further comprising modifying a risk control based on the determined single value representing operational risk.

15. The method of claim 8, wherein determining the single value representing operational risk further comprises:
determining a first combination of the plurality of items of current risk data;
determining a second combination of the plurality of items of realized risk data;
determining a third combination of the plurality of items of emerging risk data;
and summing together the following: (1) the first combination multiplied by a first coefficient, (2) the second combination multiplied by a second coefficient, and (3) the third combination multiplied by a third coefficient.

16. The method of claim 15, further comprising performing regression analysis to determine the first, second, and third coefficients.

17. The method of claim 8, further comprising collecting risk data, wherein determining the plurality of items of current, realized, and emerging risk data comprises aligning the collected risk data to a plurality of libraries.

18. The method of claim 17, further comprising performing comparisons between the determined plurality of items of current and realized risk data to determine a confidence interval.

19. A non-transitory computer-readable medium storing computer-executable instructions for performing steps, the steps comprising:
determining a plurality of items of current risk data;
determining a plurality of items of realized risk data;
determining a plurality of items of emerging risk data; and
determining, by a computer, a single value representing operational risk based on a combination of the plurality of items of current, realized, and emerging risk data.

20. The non-transitory computer-readable medium of claim 19, wherein determining the single value representing operational risk further comprises:
determining a first combination of the plurality of items of current risk data;
determining a second combination of the plurality of items of realized risk data;
determining a third combination of the plurality of items of emerging risk data;
performing regression analysis to determine first, second, and third coefficients; and
summing together the following: (1) the first combination multiplied by the first coefficient, (2) the second combination multiplied by the second coefficient, and (3) the third combination multiplied by the third coefficient.
